(19) United States
(12) Patent Application Publication
(10) Pub. No.: US 2024/0173196 A1
(43) Pub. Date: May 30, 2024

(54) METHOD FOR RELEASING CONTRACTED TISSUE

(71) Applicant: David S. Miller, Weston, CT (US)

(72) Inventor: David S. Miller, Weston, CT (US)

(21) Appl. No.: 18/070,729

(22) Filed: Nov. 29, 2022

(51) Int. Cl. A61H 7/00

(52) U.S. Cl. CPC A61H 7/001; A61H 2201/169

(57) ABSTRACT

A method of releasing contracted tissue in a subject includes identifying an area of skin of the subject under which contracted tissue is present and applying, by a tip of a device, pressure to a first point of the area of skin. The first point is located over a fiber of the contracted tissue. The tip of the massage device has a cylindrical shape having a diameter of less than 1 millimeter and a length of less than 6 millimeters. The applied pressure releases a portion of the contracted tissue under the area of skin.

### BACKGROUND

### Technical Field

The present invention relates to treatment of contracted tissue, and more particularly to releasing contracted tissue by application of pressure.

### Background

As the body ages, tissue, such as connective tissue, contracts and thickens. The contracted and hardened connective tissue interferes with mobility, causes inflammation, reduces blood flow to other tissue around joints and bones, and may cause or contribute to a number of other syndromes commonly associated with age, such as osteoarthritis, joint, shoulder and hip pain, carpal tunnel syndrome, bunions, receding gums, and (by restricting blood flow to the scalp) possibly male pattern baldness.

Several techniques, such as stretching, foam rolling, and active release therapy provide some relief from the effects of the contracted tissue, but do not reverse these conditions. Surgery is successful at releasing connective tissue, but surgery carries significant cost, lengthy recovery, and the risk of complications.

### SUMMARY

In accordance with one embodiment of the present invention, a method of releasing contracted tissue in a subject includes identifying an area of skin of the subject under which contracted tissue is present and applying, by a tip of a device, pressure to a first point of the area of skin. The first point is located over a fiber of the contracted tissue. The tip of the massage device has a cylindrical shape having a diameter of less than 1 millimeter and a length of less than 6 millimeters. The applied pressure releases a portion of the contracted tissue under the area of skin.

Alternatively or in addition, the method further includes applying, by the tip of the device, pressure to a second point of the area of skin. The second point is located along the fiber of the contracted tissue.

The contracted tissue includes tissue selected from the group consisting of connective tissue, muscle tissue, and combinations thereof. Alternatively or in addition, the contracted tissue is fibrous connective tissue.

The pressure to the first point of the area of skin is applied for a duration selected from the group consisting of more than five seconds, more than ten seconds, and at least one minute. The pressure to the second point of the area of skin is applied for a duration selected from the group consisting of more than five seconds, more than ten seconds, and at least one minute.

Alternatively or in addition, the applying step further includes applying, by the tip of the device having a fabric layer disposed thereon, pressure to the first point of the area of skin. The fabric layer may include a fabric selected from the group consisting of a microfiber fabric and a paper towel. Alternatively or in addition, the fabric layer is folded.

The tip of the device has a longitudinal axis. An angle between the longitudinal axis and the area of skin at the first point while applying pressure to the first point is selected from the group consisting of substantially 30 degrees, substantially 45 degrees, substantially 60 degrees, and substantially 90 degrees. An angle between the longitudinal axis and the area of skin at the second point while applying pressure to the second point is selected from the group consisting of substantially 30 degrees, substantially 45 degrees, substantially 60 degrees, and substantially 90 degrees.

In accordance with a related embodiment, a distance between the first point and the second point along the fiber of the contracted connective tissue is a distance selected from the group consisting of less than 5 millimeters and less than 1 centimeter.

The area of skin may be located over contracted tissue attached to a bone. Alternatively or in addition, the area of skin may be located over contracted tissue attached to a joint. Further alternatively or in addition, the contracted tissue may be part of a tendon. Releasing the portion of the contracted tissue may include breaking a chemical bond in the connective tissue.

Alternatively or in addition, identifying the area of skin includes identifying hardness under the area of skin. The pressure applied to the first point may be as high as can be tolerated by the subject

In accordance with some embodiments, the diameter of the tip is at least 0.3 millimeters. Alternatively or in addition, the length of the tip is at least 3 millimeters. The device may have a body coupled to the tip and the body may be tapered toward the tip.

In accordance with a related embodiment of the present invention, the method further includes providing caffeine to the subject for ingestion before applying pressure.

In accordance with another embodiment of the present invention, the method further includes applying, by the tip of the device, pressure while moving from the first point to the second point. The pressure applied moving from the first point to the second point may be variable.

### BRIEF DESCRIPTION OF THE DRAWINGS

The description below refers to the accompanying drawings, of which:

FIG. 1 is a cross-section of a device used in a method in accordance with an embodiment of the present invention;

FIG. 2 is a flowchart of a method for releasing contracted tissue in accordance with an embodiment of the present invention; and

FIG. 3 is a flowchart of a method for releasing contracted tissue in accordance with another embodiment of the present invention.

### DETAILED DESCRIPTION OF ILLUSTRATIVE EMBODIMENTS

As used in this description and the accompanying claims, the following terms shall have the meanings indicated, unless the context otherwise requires:

To “release” tissue includes causing release of chemical bonds in the tissue, lengthening the tissue, breaking up the tissue, and any other method that allows contracted tissue to expand and/or return to its original length.

The term “connective tissue,” in accordance with its meaning as known to a person skilled in the art, includes, but is not limited to, fibrous connective tissue, fascia, tendons, ligaments, bone, cartilage, connective tissue having collagen fibers, and connective tissue having elastic fibers.

The deficiencies of the prior art are overcome by a treatment method that includes applying intense pressure to tissue, including but not limited to connective tissue, selectively and over its length, particularly along the skull, hips, chest, shoulders, and legs, and generally where it binds to the bone. The applied intense pressure releases the tissue and allows the tissue to return to its original length. The release has two primary effects: First, once the connective tissue has released, mobility returns. The body becomes more efficient, and inflammation and pain subside. Second, blood can more easily reach the soft tissue surrounding the bone and joints.

While the descriptions and examples given herein are mostly directed to connective tissue, it is expressly understood that the claimed method is not limited to treating connective tissue. In addition to connective tissue, the contracted tissue can, for example, include muscle tissue or a combination of muscle tissue and connective tissue.

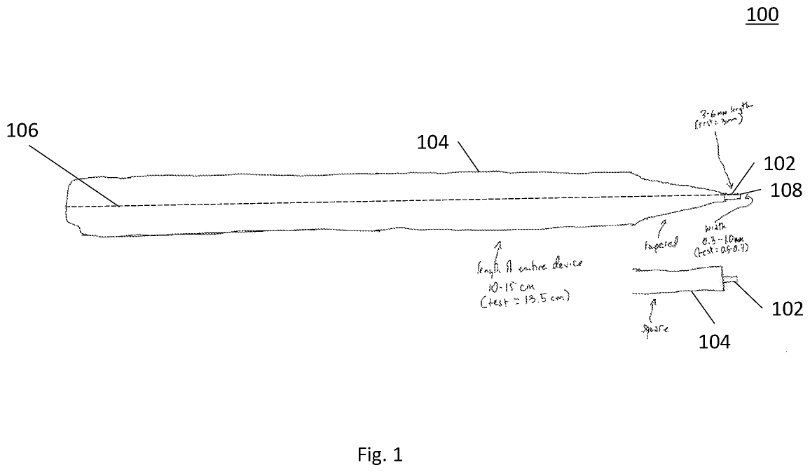

FIG. 1 is a cross-section of a device used in a treatment method in accordance with an embodiment of the present invention. Treatment device 100 includes a tip 102 and a body 104. The body 104 may have a cylindrical shape or it may be a cuboid, such as a rectangular cuboid. However, it is also expressly contemplated that the shape of the body may be any other prism, such as a hexagonal prism. The body 104 and tip 102 have a longitudinal axis 106. The combined length of the body 104 and tip 102 along the longitudinal axis 106 may be between 10 centimeters and 15 centimeters. However, the combined length may also have any other length as may be practical for the circumstances of a particular treatment. The body 104 may be tapered toward the tip 102, or the body 104 may not be tapered.

The body 104 is coupled to the tip 102. The tip 102 may have a cylindrical shape or it may be a rectangular cuboid. In either case, an end 108 of the tip 102 is flat, having the shape of a circle or a rectangle, respectively. The tip 102 may have a length of at least 3 millimeters. The maximum length of the tip 102 may be 6 millimeters. The tip 102 may have a diameter and/or width of at least 0.3 millimeters. The maximum diameter and/or width of the tip 102 may be 1 millimeter. The small size of the tip 102 allows the device to apply high pressure to a small surface area of the skin and therefore allows for greater penetration of the pressure to the contracted tissue as opposed to a device with a larger tip. The tip 102 is fabricated from a suitable material, such as metal. The tip 102 may optionally be coated with a rubber or plastic coating.

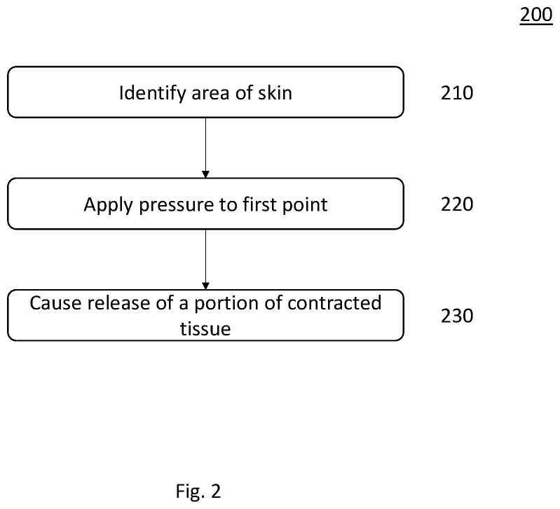

FIG. 2 is a flowchart of a treatment method 200 for releasing contracted tissue in accordance with an embodiment of the present invention. In step 210, an area of skin of a subject is identified under which contracted tissue is present. The subject may be a human subject, including but not limited to a patient or therapy client, or it may be a non-human subject such as a horse, a dog, a cat, or another animal. Identifying the area of skin may include identifying hardness under the area of skin. This hardness may indicate the presence of contracted tissue. It may be present on the top of the skull (generally following male pattern baldness), along the base of the skull where the skull meets the neck, or as hardness along the bones of the forearm, around the shin bones, on the surface of the shoulder plate, along the ribs, around the jaw, and around the hip. However, hardness may also be present along any other contracted tissue in the body. In addition, the step of identifying the area of skin may, in addition or alternatively, also include any other procedure of identifying contracted tissue known to a person having skill in the art. The contracted tissue includes connective tissue and/or muscular tissue. Contracted connective tissue may include fibrous connective tissue and may be part of a tendon, a ligament, and/or part of fascia. Contracted muscular tissue may correspond to a trigger point in a muscle. In addition, the contracted connective and/or muscular tissue may be attached to another part of the subject's body, such as a bone or a joint.

In step 220, pressure is applied to a first point of the area of skin. The pressure is applied using a treatment device such as treatment device 100 described in detail above. The pressure is applied by the tip 102 of treatment device 100. The first point, to which the pressure is applied, is located over a fiber of the contracted tissue.

The pressure may be applied by the tip of the device through a piece of fabric that is disposed on the tip of the device such that it is placed between the tip and the area of skin. The piece of fabric may exemplarily be a microfiber cloth or a paper towel, but any other fabric known to a person having skill in the art may be used. The fabric may also be folded once, twice, or more depending on the subject's sensitivity. The applied pressure therefore can be varied by the type of fabric used and by how often the fabric is folded over.

The tip of the device is then pressed firmly (optionally through the piece of fabric) onto the skin over the contracted tissue at the first point. The pressure applied to the first point may be as high as can be tolerated by the subject. In addition, the subject may be given caffeine for ingestion before applying pressure. Giving caffeine to the subject enhances the effect of the treatment method. However, it is expressly contemplated that the method may be performed without the subject ingesting caffeine or that any other substance that enhances the effect of the treatment and is known to a person skilled in the art may be used.

The pressure to the first point is applied for a certain duration of time. Advantageously, the pressure is applied for at least one minute if the subject can tolerate it. Alternatively, the pressure can be applied for shorter durations, such as for more than 5 seconds, for more than 10 seconds, or for more than 30 seconds. Pressure may be applied for additional time in areas where connective tissue attaches to a bone (including a joint), and other points where there is thickness, particularly if there is a sensation of release. No additional time should be spent where there is no sensation of release; the treatment time is better spent finding areas of where a sensation of release is present.

Alternatively, device 100 may be used as a probe along the surface of bone, applying intense pressure to the skin and thus to the connective tissue that runs along the bone. Such connective tissue has a limited number of nerves, and most nerves in bone are found along blood vessels. Intense pressure is therefore felt only as pressure without feeling of pain in the connective tissue or bone.

As described above, the tip 102 of the treatment device 100 has a longitudinal axis 106. The pressure to the first point may be applied such that an angle between the longitudinal axis 106 and the surface of the skin at the first point while applying pressure is substantially 90 degrees. Alternatively, the angle between the longitudinal axis and the skin may be smaller, such as substantially 30 degrees, substantially 45 degrees, or substantially 60 degrees. It is also expressly contemplated that the angle between the tip 102 and the skin may be varied while applying pressure to the first point.

In step 230, the applied pressure causes release of a portion of the contracted tissue under the area of skin. Connective tissue is arranged in nodules, particularly around bones such as the hips, the lower edges of the ribs on each side, the solar plexus, where the base of the skull meets the neck, where the collarbones meet the shoulders, the wrists, the ankles, the sides of the arms, and the elbows. These nodules have multiple fibrous connections to other nodules. Each of these connections needs to be released for the nodule to release. In addition, as the treated nodule releases, there is a cascading effect which causes other connected nodules to begin releasing as well. It is also emphasized that the applied pressure need not release the entirety of the contracted tissue under the area of skin. Releasing a portion of the contracted tissue is sufficient to gain an advantageous effect.

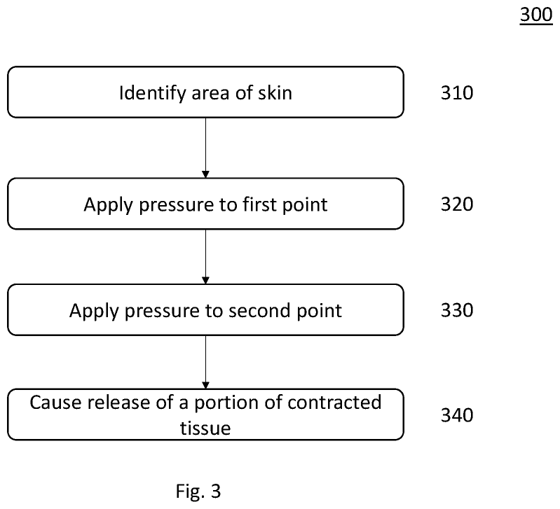

FIG. 3 shows a flowchart of a treatment method 300 for releasing contracted tissue in accordance with another embodiment of the present invention. In step 310, an area of skin of the subject is identified as described above with reference to step 210 of method 200. In step 320, pressure is applied to a first point of the area of skin as described above with reference to step 220 of method 200. In step 330, pressure is applied to a second point of the area of skin. The second point, like the first point, is located along the fiber of contracted tissue. The pressure is applied to the second point with the tip 102 of the treatment device in substantially the same manner and with the same options as pressure is applied to the first point as described in detail above with reference to step 210 of method 200: a piece of fabric may be used, and the duration and angle of applying pressure may be the same or may be similar to the ones used at the first point. However, there is no requirement that the duration for which pressure is applied at the second point be the same as at the first point. Illustratively, pressure could be applied for one minute at the first point and for 30 seconds at the second point. There is also no requirement that the angle at which pressure is applied at the second point be the same as the first point. For example, pressure could be applied at an angle of 45 degrees at the first point and at an angle of 90 degrees at the second point. Similarly, pressure may, for example, be applied at the first point through a piece fabric and at the second point without the use of a piece of fabric, or vice versa.

The distance between the first point and the second point along the fiber of the contracted tissue may be several millimeters. Illustratively, the distance may be less than 5 millimeters, less than 5 millimeters, or less than 1 centimeter. However, as known to the person skilled in the art, the distance is chosen based on the specific anatomy of the area to be treated and/or based on the location of the identified nodules of contracted tissue.

In addition, the method 300 may include applying pressure while moving from the first point to the second point along the fiber of the contracted tissue. The pressure may be applied substantially similarly to what is described above in reference to applying pressure to the first and second points. The pressure applied to the skin between the first and second points may also be variable. For example, the pressure applied close to the first point may be higher than close to the second point, or vice versa. Any variation of pressure between the first and second points is expressly contemplated. In some embodiments, pressure is applied by the treatment device 100 on the contracted tissue moving from the first point to the second point without any break in contact with the contracted tissue underneath. Alternatively, a pressure can be applied by the treatment device 100 to a single point on the contracted tissue for a particular duration prior to lifting the treatment device 100 away from that point of contact and applying a pressure at a second point that is at a different location relative to the first point.

In step 340, the applied causes release of a portion of the contracted tissue under the area of skin, as described above with reference to step 230 of method 200.

The foregoing description described certain example embodiments. It will be apparent, however, that other variations and modifications may be made to the described embodiments, with the attainment of some or all of their advantages. Accordingly, the foregoing description is to be taken only by way of example, and not to otherwise limit the scope of the disclosure. It is the object of the appended claims to cover all such variations and modifications as come within the true spirit and scope of the disclosure.

What is claimed is:

1. A method for releasing contracted tissue in a subject, the method comprising:
identifying an area of skin of the subject under which contracted tissue is present;
applying, by a tip of a device, pressure to a first point of the area of skin,
wherein the first point is located over a fiber of the contracted tissue;
wherein the tip of the massage device has a cylindrical shape having a diameter of less than 1 millimeter and a length of less than 6 millimeters; and
wherein the applied pressure causes release of a portion of the contracted tissue under the area of skin.

2. The method of claim 1, further comprising applying, by the tip of the device, pressure to a second point of the area of skin, wherein the second point is located along the fiber of the contracted tissue.

3. The method of claim 1, wherein the contracted tissue includes tissue selected from the group consisting of connective tissue, muscle tissue, and combinations thereof.

4. The method of claim 1, wherein the contracted tissue is fibrous connective tissue.

5. The method of claim 1, wherein the pressure to the first point of the area of skin is applied for a duration selected from the group consisting of more than five seconds, more than ten seconds, and at least one minute.

6. The method of claim 2, wherein the pressure to the second point of the area of skin is applied for a duration selected from the group consisting of more than five seconds, more than ten seconds, and at least one minute.

7. The method of claim 1, the applying step further comprising applying, by the tip of the device having a fabric layer disposed thereon, pressure to the first point of the area of skin.

8. The method of claim 1, wherein the tip of the device has a longitudinal axis and wherein an angle between the longitudinal axis and the area of skin at the first point while applying pressure to the first point is selected from the group consisting of substantially 30 degrees, substantially 45 degrees, substantially 60 degrees, and substantially 90 degrees.

9. The method of claim 2, wherein the tip of the device has a longitudinal axis and wherein an angle between the longitudinal axis and the area of skin at the second point while applying pressure to the second point is selected from the group consisting of substantially 30 degrees, substantially 45 degrees, substantially 60 degrees, and substantially 90 degrees.

10. The method of claim 2, wherein a distance between the first point and the second point along the fiber of the contracted tissue is a distance selected from the group consisting of less than 5 millimeters and less than 1 centimeter.

11. The method of claim 2, further comprising applying, by the tip of the device, pressure while moving from the first point to the second point.

12. The method of claim 11, wherein the pressure applied moving from the first point to the second point is variable.

13. The method of claim 1, wherein the area of skin is located over contracted tissue attached to a bone.

14. The method of claim 1, wherein the area of skin is located over contracted tissue attached to a joint.

15. The method of claim 1, further comprising providing caffeine to the subject for ingestion before applying pressure.

16. The method of claim 7, wherein the fabric layer includes a fabric selected from the group consisting of a microfiber fabric and a paper towel.

17. The method of claim 7, wherein the fabric layer is folded.

18. The method of claim 1, wherein the contracted tissue is part of a tendon.

19. The method of claim 1, wherein releasing the portion of the contracted tissue comprises breaking a chemical bond in the tissue.

20. The method of claim 1, wherein the diameter of the tip is at least 0.3 millimeter.

21. The method of claim 1, wherein the length of the tip is at least 3 millimeters.

22. The method of claim 1, wherein the device has a body coupled to the tip and wherein the body is tapered toward the tip.

23. The method of claim 1, wherein identifying the area of skin includes identifying hardness under the area of skin.

24. The method of claim 1, wherein the pressure applied to the first point is as high as can be tolerated by the subject.
